(19) United States
(12) Patent Application Publication
(10) Pub. No.: US 2011/0241429 A1
(43) Pub. Date: Oct. 6, 2011

(54) BATTERY BACKUP SYSTEM - A METHOD FOR A COFFEEMAKER

(76) Inventor: HENRY WHITMORE, Hancock, ME (US)

(21) Appl. No.: 13/076,123

(22) Filed: Mar. 30, 2011

Related U.S. Application Data
(60) Provisional application No. 61/318,942, filed on Mar. 30, 2010.

(51) Int. Cl. H02J 9/00; H02J 7/00

(52) U.S. Cl. 307/66

(57) ABSTRACT

A power backup system for a coffeemaker comprising: an AC power source; a battery charger, where the battery charger receives power from the AC power source; a DC power source, where the DC power source remains charged by the battery charger; and a DC/AC inverter, where said inverter inverts the AC power to DC power upon activation of the power backup system and supplies power to the coffeemaker. The power backup system may further include a clock/timing device, where the clock/timing device sets a brewing sequence for the coffeemaker and receives power from AC power source, or if AC power is unavailable the DC power source. The power backup system may also include an automatic relay, where the automatic relay connects the DC/AC inverter to the timing device and other electrical components of the coffeemaker.

### CROSS REFERENCE TO OTHER APPLICATIONS

This application claims priority to U.S. Provisional Application Ser. No. 61/318,942 filed on Mar. 30, 2010.

### BACKGROUND OF THE INVENTION

1. Field of Invention

The present invention relates to a battery backup system that provides an electrical backup for automatic coffeemakers.

2. Description of Related Art

A coffeemaker is a common appliance that is used in many homes to brew coffee. A coffeemaker usually has a carafe that is placed within a coffeemaker to receive coffee that drips from the coffeemaker. Many coffeemakers used in most households include electronic controls to control the flow and degree of percolation of the coffeemaker. Many of the controls involve or are related to the strength of coffee and may further provide timing sequences for the brewing of the coffee. Coffeemakers may also be set to begin brewing at a particular time if a timer is also provided on the coffeemaker.

Many coffee drinkers prepare their coffee for automatic brewing the night before so that they may enjoy a cup of coffee when they awake in the morning. The setting of automated coffee brewing is dependent upon the settings of the timer and a clock provided on a coffeemaker. If an electrical outage should occur during the night many times the timer and coffeemaker are disabled due to lack of power. In order to avoid this problem it would be advantageous to have a battery backup system installed within the coffeemaker to ensure that if a power failure does occur the timing sequence and brewing mechanisms remain set as desired by the user.

### SUMMARY OF THE INVENTION

The present invention relates to a power backup system for a coffeemaker comprising: an AC power source; a battery charger, where the battery charger receives power from the AC power source; a DC power source, where the DC power source remains charged by the battery charger; and a DC/AC inverter, where said inverter inverts the AC power to DC power upon activation of the power backup system and supplies power to the coffeemaker. The power backup system may further include a clock/timing device, where the clock/timing device sets a brewing sequence for the coffeemaker and receives power from AC power source, or if AC power is unavailable the DC power source. The power backup system may also include an automatic relay, where the automatic relay connects the DC/AC inverter to the timing device and other electrical components of the coffeemaker.

### BRIEF DESCRIPTION OF DRAWINGS

FIG. 1 depicts a coffeemaker with a power backup system provided.

### DETAILED DESCRIPTION

The present invention relates to a system for providing backup power to a coffeemaker in case of a power failure in order to protect preselected brew settings by the user. The present invention provides a means to maintain power to the coffeemaker in case of an electrical failure and therefore ensures that the coffeemaker continues to operate as desired by the user.

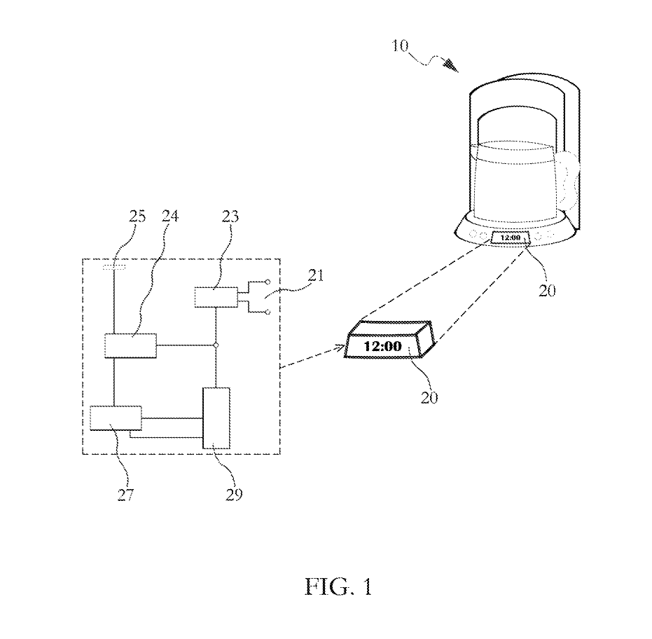

FIG. 1 depicts a power backup system for a coffeemaker as contemplated by the present invention. A coffeemaker 10 is shown that includes a clock/timing device 20. The clock/timing device 20 provides a means to set the brewing sequence for the coffeemaker 10. In accordance with the present invention, the clock/timer 20 includes a battery backup system installed therein as depicted in the associated schematic.

The schematic of the power backup system includes a connection point 21 that connects to the timer 20. The backup system includes an automatic relay 23, an AC power source 25, a battery charger 24, a DC power source 27 and a DC/AC inverter 29. The interconnections between these components provide the structure for the power backup system for the coffeemaker 10. AC power is provided via the AC power outlet 25, which is connected internally in the coffeemaker to an AC power outlet provided on the coffeemaker 10. The AC power provides power to the battery charger 24, which in turn charges the DC power source 27. The DC power source 27 will therefore remain in a charged state until needed upon failure of AC power. Should the AC power fail, the coffeemaker 10 and the timer 20 use the DC power supply 27 via the DC/AC inverter 29. The automatic relay 23 connects the DC/AC power inverter 29 to the timer 20 and the further electrical components of the coffeemaker 10.

As contemplated, this particular schematic for a power backup system supplies the power to the coffeemaker in the event of a power failure. This ensures that the coffeemaker's settings remain constant and that the clock/timer continues to function as set by the user. The power backup system is activated upon the disconnection of AC power to the coffeemaker 10 and therefore it initiates the DC power as the source of energy. This ensures that all settings and brew times set by the user remain intact without disruption. The instant invention has been shown and described in what it considers to be the most practical and preferred embodiments. It is recognized, however, that departures may be made there from within the scope of the invention and that obvious modifications will occur to a person skilled in the art.

What is claimed is:

1. A power backup system for a coffeemaker comprising:
a. an AC power source;
b. a battery charger, where the battery charger receives power from the AC power source;
c. a DC power source, where the DC power source remains charged by the battery charger; and
d. a DC/AC inverter, where said inverter inverts the AC power to DC upon activation of the power backup system and supplies power to the coffeemaker.

2. The power backup system according to claim 1, further comprising a clock/timing device, where the clock/timing device provides a means to set a brewing sequence for the coffeemaker and receives power from AC power source, or if AC power is unavailable the DC power source.

3. The power backup system according to claim 1, further comprising an automatic relay, where the automatic relay connects the DC/AC inverter to the timing device and other electrical components of the coffeemaker.

4. A method of providing an alternative power source for a coffeemaker comprising the step of:
a. providing a AC power source to the coffeemaker as a primary power source;
b. providing a DC power source to the coffeemaker as a secondary power source;
c. providing a DC/AC inverter for the coffeemaker;
d. inverting to DC power when AC power is unavailable; and
e. inverting back to AC power upon availability.

5. The method according to claim 4, where the steps of inverting are achieved by using an automatic relay.
